(19) United States
(12) Patent Application Publication
(10) Pub. No.: US 2008/0106422 A1
(43) Pub. Date: May 8, 2008

(54) Pool light with safety alarm and sensor array

(76) Inventors: Travis Sparks, Flint, TX (US); Jonathan Scott Ratliff, Midlothian, TX (US)

Correspondence Address: Mr. Christopher John Rourk;Jackson Walker LLP, 901 Main Street, Suite 6000, DALLAS, TX, 75202, US

(21) Appl. No.: 11/975,423

(22) Filed: Oct. 19, 2007

Related U.S. Application Data
(60) Provisional application No. 60/862,137, filed on Oct. 19, 2006.

(51) Int. Cl. G08B 23/00

(52) U.S. Cl. 340/573.6

(57) ABSTRACT

A system for monitoring a swimming pool is provided. The system includes a parabolic housing and a seismic sensor at or near a focal point of the parabolic housing, a pressure sensor, and an optical sensor, each sensor generating a signal. Sensor monitoring systems receive the signals and analyze the signals to determine whether an immersion event has occurred.

### RELATED APPLICATIONS

This application claims priority to U.S. provisional application 60/862,137, filed Oct. 19, 2006, entitled “Pool Light with Safety Alarm and Sensor Array,” which is hereby incorporated by reference for all purposes.

### FIELD OF THE INVENTION

The present invention relates to systems for monitoring swimming pools, and more particularly to a pool light with a safety alarm and sensor array that uses the pool light to monitor pool safety.

### BACKGROUND OF THE INVENTION

Pool safety monitors are known in the art. Such pool monitors typically detect sound and analyze the sound to determine if a splash or other sound is generated that indicated that an object, such as a person, has fallen into a pool.

Such prior art pool safety monitors suffer from numerous problems. If a person enters a pool slowly, then no sound may be generated, resulting in a failure to detect the entry. Likewise, if rain, leaves or other objects enter the pool or if other sounds are received (such as a splash from a neighbors pool), a false alarm can be generated. As such, while pool safety monitors are known, due to their poor reliability and tendency to fail to generate alarms or to generate false alarms, pool safety monitors are not regarded as reliable or failsafe.

### SUMMARY OF THE INVENTION

Therefore, a pool safety monitor is provided that reduces or eliminates false indications of pool entry and that can detect noiseless pool entry.

In accordance with an exemplary embodiment of the invention, a system for monitoring a swimming pool is provided. The system includes a parabolic housing and a seismic sensor at or near a focal point of the parabolic housing, a pressure sensor, and an optical sensor, each sensor generating a signal. Sensor monitoring systems receive the signals and analyze the signals to determine whether an immersion event has occurred.

The present invention provides many important technical advantages. One important technical advantage of the present invention is a system and method for pool safety monitoring that does not rely on audio data to detect pool entry, so that quiet entries can be detected and false alarms that would be caused by sounds unrelated to pool entry are avoided.

Those skilled in the art will further appreciate the advantages and superior features of the invention together with other important aspects thereof on reading the detailed description that follows in conjunction with the drawings.

### BRIEF DESCRIPTION OF THE DRAWINGS

FIG. 1 is a diagram of a system for providing a pool light with safety alarm and sensor array in accordance with an exemplary embodiment of the present invention;

FIG. 2 is a diagram of a system for providing a pool light with safety alarm and sensor array in accordance with an exemplary embodiment of the present invention;

FIG. 3 is a diagram of a system for providing an accidental immersion alarm in accordance with an exemplary embodiment of the present invention;

FIG. 4 is a diagram of a system for providing a removable sensor array in accordance with an exemplary embodiment of the present invention;

FIG. 5 is a diagram of a sensor housing assembly in accordance with an exemplary embodiment of the present invention;

FIG. 6 is a diagram of a system for monitoring swimming pool conditions in accordance with an exemplary embodiment of the present invention;

FIG. 7 is a flow chart of a method for monitoring swimming pools in accordance with an exemplary embodiment of the present invention; and

FIG. 8 is a flow chart of a method for training a sensor to detect an immersion event in accordance with an exemplary embodiment of the present invention.

### DETAILED DESCRIPTION OF PREFERRED EMBODIMENTS

In the description which follows, like parts are marked throughout the specification and drawing with the same reference numerals, respectively. The drawing figures may not be to scale and certain components may be shown in generalized or schematic form and identified by commercial designations in the interest of clarity and conciseness.

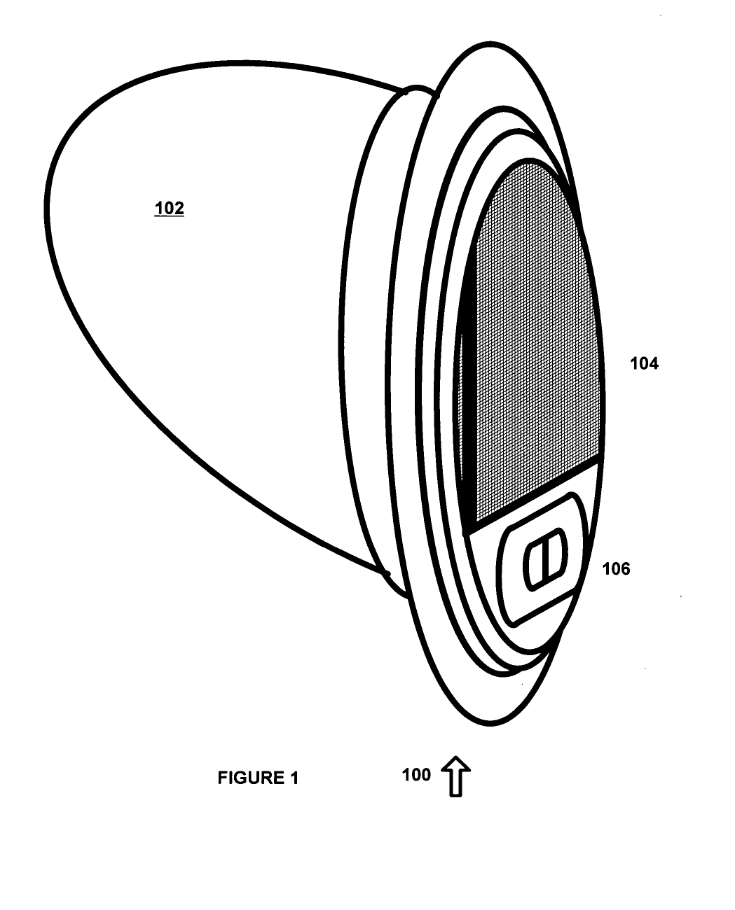

FIG. 1 is a diagram of a system 100 for providing a pool light with safety alarm and sensor array in accordance with an exemplary embodiment of the present invention. System 100 provides integrated pool lighting, pool safety and pool chemistry monitoring. System 100 includes waterproof housing 102 that is mounted in a standard size pool lighting niche or in other suitable configurations, so as to support new and retrofitted applications. System 100 utilizes the parabolic shape of the standard pool lighting niche as a reflector to amplify pressure signals, seismic signals, and other suitable signals for use in immersion detection.

System 100 provides an accidental immersion alarm that utilizes multiple sensors, including light, acoustic, infrared, and pressure sensors, and which can monitor conditions through sensor window 106, by utilizing the parabolic shape of the lighting niche as a reflector and amplifier, or in other suitable manners. Sensor window 106 or other suitable structures can provide access for water chemistry monitoring to provide immediate and full time display of pool water quality, such as by measuring pH levels, temperature, clarity, solid content and sanitizer action. LED pool light 104 can be used to provide a light source for use in monitoring water quality, detecting large and small object motion detection, and can be controlled using adjustable and dimmable fixed color light, random multi-color light show, and sound and swimmer action responsive light show modes.

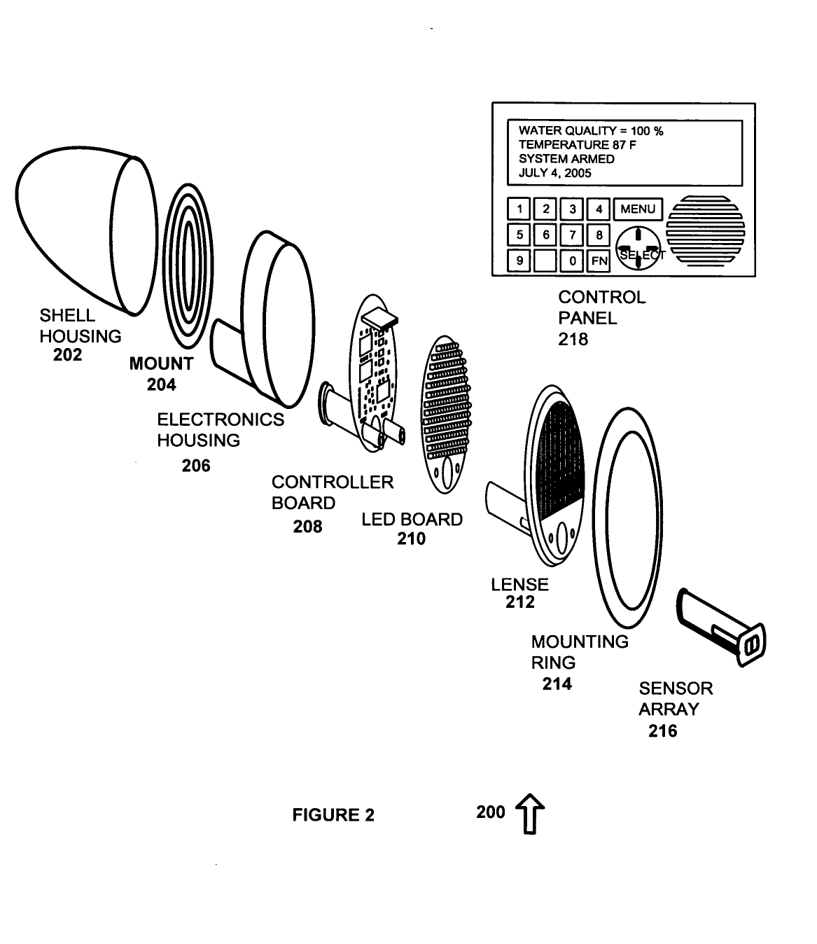

FIG. 2 is a diagram of a system 200 for providing a pool light with safety alarm and sensor array in accordance with an exemplary embodiment of the present invention. System 200 includes shell housing 202, which can be fabricated from molded plastic, resin, fiberglass, copper, stainless steel or other suitable corrosion resistant materials that do not absorb or interfere with the detection of reflected audio and seismic signals. Mount 204 is a corrugated mounting component for one or more sensors, such as a seismic sensor, a strain gauge, or other suitable sensors. Mount 204 is placed at a focal point of the parabolic shape of shell housing 202 and the lighting niche which holds shell housing 202. Electronics housing 206 fits within shell housing 202 and holds controller board 208, which performs in-unit control of system 200. LED board 210 is coupled to controller board 208, and receives power and control signals from controller board 208. As used herein, the term “coupled” and its cognate terms such as “couples” or “couple,” can include a physical connection (such as a wire, optical fiber, or a telecommunications medium), a virtual connection (such as through randomly assigned memory locations of a data memory device or a hypertext transfer protocol (HTTP) link), a logical connection (such as through one or more semiconductor devices in an integrated circuit), or other suitable connections.

Lens 212 is placed over LED board 210 and provides an environmental seal between the pool water and controller board 208 and LED board 210, while allowing the LED components of LED board 210 to receive water cooling, which decreases the operating temperature of the LED components and increases component life. Mounting ring 214 is used to secure system 200 to a swimming pool light housing, and sensor array 216 is placed within a sensor channel of lens 212.

A control panel 218 operates in conjunction with sensor array 216 and controller board 208, such as through a wireless, wire line, optical fiber, or other suitable data communication channel. Control panel 218 allows a user to control system operation settings such as to arm or disarm the system, to receive information on pool water conditions such as temperature, pH and cleanliness, to control lighting system operation such as to provide aesthetic light operation, or to perform other suitable functions. Control panel 218 also provides information to a user, such as water or system diagnostics, component failure indications or warnings, or other suitable data.

In operation, system 200 provides combined lighting, immersion detection and water quality monitoring functions. The lighting functions of system 200 are utilized for both immersion detection and water quality monitoring, such as by measuring the reflectivity of objects in the water, particles in the water, and the motions of both. System 200 thus determines the motion of large objects in the water, as well as turbidity, and the absorption and reflectivity of particles in the water at various light wavelengths so as to determine their identity and nature. In this manner, sanitizer action, water purity controls, and determination of organic matter and inorganic mater concentrations can be made. Likewise, system 200 performs seismic monitoring by utilizing the hyperbolic shape of the lighting niche and housing to amplify seismic signals that can be processed to determine changes in the resonant frequency of the swimming pool, which will have different values if the swimming pool is empty or if a person or other massive object is in the swimming pool.

Seismic disturbances in the firmament surrounding the pool, motions in the water, and disturbances in the air above the pool are all monitored by a strain gauge sensor mounted on the inner surface of corrugated mount 204. The strain gauge signal is transmitted to controller board 208, control panel 218 or other suitable systems for signal processing and analysis. In an alternate exemplary embodiment, accelerometer functions can be derived from the strain gauge signals, such as to monitor the rise and decay rate of pressure waves deflecting off the corrugated surface of the enclosure.

In another exemplary embodiment of the present invention, an AC waveform of sufficient amplitude is provided by controller board 204 or other suitable systems to drive the strain gauge as an acoustic device, converting the corrugated surface of the enclosure to an audio transmitter instead of a seismic or pressure receiver. In this manner, an acoustic pulse can be generated and transmitted to the water of the swimming pool at controllable frequencies. The resonant frequency of the swimming pool can be measured based on the response measured by system 200, such as by the strain gauge, either in terms of a fundamental frequency or in octaves, where objects immersed in the water will change this measured frequency so as to allow detection of objects to be performed in this manner.

When a low noise power supply is utilized to drive the LED light source of LED printed circuit board 210 instead of a pulse width modulated signal or other sources which can create harmonic noise components, gains on the order of a factor of 200 can be obtained to amplify the signal from the strain gauge without background noise being a factor. The signal from the strain gauge can also be passed through a comparator that has a controlled threshold, thus generating a histogram scoring of measured vibrations. The scores can be saved to nonvolatile memory or other suitable memory devices and subsequently accessed to perform comparisons to facilitate the sound recognition process.

The algorithm for signal recognition from the strain gauge signals scores a measured signal relative to stored histogram profiles. Histogram profiles can be developed using a standard toddler sized and weighted rescue manikin, which is dropped into a reference pool from multiple locations around the perimeter of the pool. The manikin is dropped into the water using three specific drop techniques. The first technique is falling into the water from a standing position, the second technique is falling into the water from a sitting position with the manikin's legs in the water, and the third technique is the manikin rolled into the water while lying on its side at the edge of the pool. These techniques can be referred to as “tuning” or “training.” An exemplary embodiment of tuning may also be referred to as mimicking an emersion event.

The scoring algorithm for the seismic sensor is based on signals derived during the mimicking of emersion events at several band pass filter settings where the filter removes high and low frequencies. The midpoint of the amplitude is determined and the comparator derives a count from a specific narrow band of frequencies. This count is then stored in nonvolatile memory and becomes part of the histogram used to determine whether or not an emersion event has occurred. In one exemplary embodiment, the individual bands of frequencies that are scored can be 0 Hz to 200 Hz, 200 Hz to 600 Hz, and 600 Hz to 1000 Hz. Other suitable frequency ranges can also or alternatively be utilized. The accelerometer portion of the algorithm develops statistical scoring by monitoring the attack and decay rate of a plurality of seismic events and uses scoring to determine a pattern for normal background noise so that it can be distinguished from an emersion event. During training and tuning of the system, emersion events are mimicked and the signals derived from the sensor output are used to generate an overall histogram of amplitudes in a frequency bandwith, such as 0 Hz to 200 Hz, for a predetermined period of time such as two seconds, and this histogram is saved to nonvolatile memory so that it can be used to compare with other sensor outputs when the system is armed. A standard set of the scoring profiles and histograms are thus preprogrammed into nonvolatile memory during manufacture so that the system will have a baseline of parameters that allow it to function “out of the box” with histograms that are based on an average sized pool or a pool having a size based on the pool that the sensor is being installed on. Likewise, customized tuning can be utilized for unique shaped pools or to otherwise optimize system response.

In one exemplary embodiment, a differential pressure sensor is used with water pressure directed to both sides of a diaphragm by means of a tube connected from the top of the enclosure to one side of the sensor and another tube from the bottom of the enclosure to the other side of the sensor. In this manner, the sensor can be placed at any depth without affecting its operation, sensitivity, or operating characteristics. A pressure delay tube can be constructed by causing the tube connected from the bottom of the pressure sensor to the bottom of the enclosure to be at least four times as long as the tube connected from the top of the pressure sensor to the top of the enclosure, so as to increase the signal output across the pressure transducer. In one exemplary embodiment, the distance from the top tube inlet to the bottom tube inlet can be approximately seven inches, and because water is essentially incompressible, there will be very little pressure differential at 7 inches of water depth. By employing a delay tube, the pressure sensor can detect wave action with an improved signal output, thus improving the overall sensitivity of the pressure sensor.

The scoring algorithm for the pressure sensor employs rhythm counting. As pressure rhythmically rises and falls because of wind driven ripples on the surface of the water, the pressure sensor algorithm measures the period between crests and establishes a wave “beat.” The wave beat is constantly adjusted by running averages and background anomalies are removed by employing a Fast Fourier Transform (FFT). Historical wave activity is also calculated using least squares regression to predict the expected wave activity at any given time. The variance between the predicted wave beat and anomalies to the predicted wave pattern are used to create a score that is compared to sensitivity settings to determine if the pressure sensor system is indicating that an emersion event has occurred.

Optical sensors consist of both infrared and visible light sensors. A single infrared sensor, taking advantage of the little electrical noise in the system, is amplified with programmable gains of 0 to 1000 and drives a simple comparator circuit, whose output is connected to an interruptible input so that a positive signal from the circuit can be rapidly detected. Since infrared light waves do not travel well in water and immersion in water will typically lower the immersed object's temperature to the same temperature of the water in a short period of time, the infrared sensor is strictly employed to signal when an object with a temperature greater than the water has been immersed within the range of the sensor.

The visible light sensors are arranged in a differential pattern within least two sensors, although alternate embodiments of the present invention may employ a multitude of sensors, and through differentiating the light levels reported by the different visible light sensors, a determination of the evenness of light reaching the system can be achieved. If the levels change between sensors abruptly, such as within a period of less than two seconds, then the light sensor signals can be used to make a determination based on the time and the amplitude of the differences between multiple sensors, and a lookup table of acceptable variances established through training can be used to indicate whether an immersion event has occurred. At night, when the ambient light is too low with visible light sensors to operate properly, a luminary device such as LED board 210 can be employed to strobe the water every few seconds and look for differences in the light received by the visible light sensors.

Alternate exemplary embodiments of the present invention can include imaging sensors, capable of visible and infrared imaging, that employ motion detecting software and edge detecting software capable of detecting movement and shape of objects in the water, determining whether the object in the water matches the profile of the human form or a domestic pet, or other suitable data. Strobing of the luminary device at night when continuous illumination of the swimming pool is not desired may be used to enhance the motion detect ability of the imaging sensors by allowing for multiple discrete images to be received and compared for differences even in low ambient lighting.

Different combinations of scoring, signal levels, and positive indications that emersion event has occurred are compared to the sensitivity level set by the user. If the system is set at its highest sensitivity, and any indication from any subsystem or direct sensor input that exceeds a predefined threshold occurs, then the system will output an alarm condition. If the system is set at its lowest sensitivity, then all of the subsystems software and sensor inputs must agree that an emersion event has occurred before the system will output alarm condition. In addition, a gate alarm, door alarm, window alarm, or other suitable alarms can be used that are integrated with and communicate with the controller. Triggering of such alarms can also be used to change the sensitivity level of the system, such as from a low setting to a high setting.

In another exemplary embodiment, triggering of a door alarm and subsequent triggering of a gate alarm within a user specified time period can be used to change the sensitivity level of the system, such as from a low setting to a high setting. Likewise, triggering of sensitivity level changes can be based on detection of approaching footsteps by the seismic sensor.

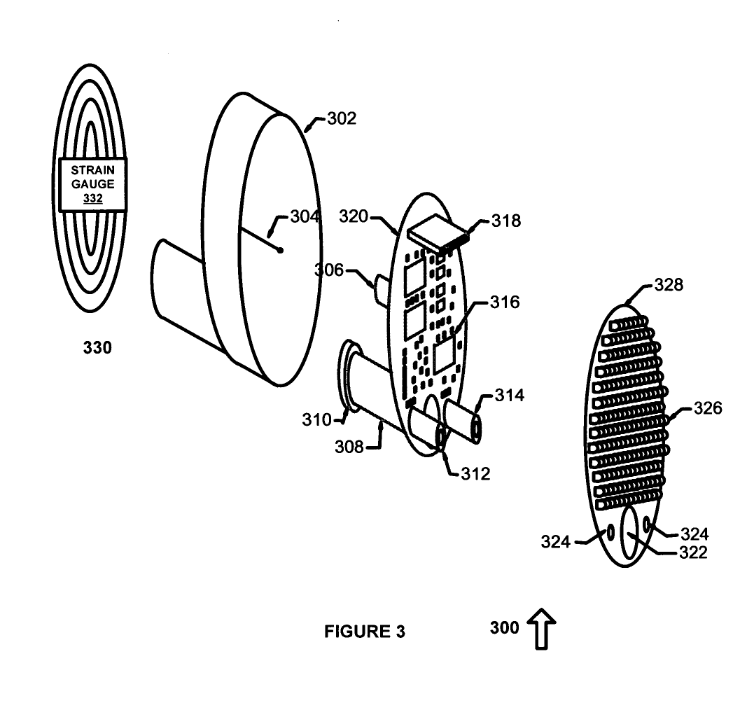

FIG. 3 is a diagram of a system 300 for providing an accidental immersion alarm in accordance with an exemplary embodiment of the present invention. System 300 utilizes multiple sensors and software to analyze audio data, light data, pressure data or other suitable data so as to increase sensitivity to emergency situations and to reduce activation of an alarm in the absence of an emergency situation.

In one exemplary embodiment, system 300 detects audio signals transmitted through the water, filters and enhances the detected audio signals, and then compares the detected audio signals to stored sound and pressure profiles to identify events such as splashing, cavitations in the water, thrashing in the water, vocalizations, and other indicators of distress. System 300 can thus be used to distinguish between normal audio signals, such as those generated by a pool circulation pump, sweeper devices, and audio signals generated in an emergency situation, such as when a person falls in the water and is unable to swim. In one exemplary embodiment of the present invention, system 300 includes rear electronics housing 302, magnetic armature 304, and pick up coil 306, although other suitable sensors such as diaphragm sensors, piezoelectric sensors, dynamic sensors, carbon sensors, ceramic sensors and crystal sensors can also or alternatively be used. Pick up coil 306 detects water pressure variations, such as splashes, wave actions, or other pressure signals from the swimming pool water and can be used to monitor changes in pressure variations over time to determine if sudden changes have occurred. Other data such as water pressure, water level, atmospheric pressure, rain activity, wind action, swimmer activity, detection and integration of sounds, music, splash and other impact or percussive events can be detected to provide the user with information and communicate control events and inputs to the system controls.

System 300 also includes removable sensor housing 308, coil 310, removable sensor port 312, coils 312 and 314, rear electronics housing 316, connector 318, controller printed circuit board 320, LED printed circuit board sensor ports 322 and 324, LED array 326, LED printed circuit board 328, corrugated mount 330 and strain gauge 332. Coils 310, 312 and 314 are used to magnetically couple power and data to a removable sensor such as sensor array 214 or other suitable sensors, so as to allow power to be provided to the removable sensor and to allow data to be transferred to and from the removable sensor without the need for an electrical connection, allowing for the enclosures to be independent and completely sealed from the water. Connector 318 provides power and control signals to LED printed circuit board 328. Removable sensor port 312 and LED printed circuit board sensor ports 322 and 324 allow a removable sensor to be inserted into removable sensor housing 308.

Corrugated mount 330 is used to place strain gauge 332 at or near the focus point of the hyperbolic cavity in which system 300 is placed, so as to amplify seismic signals generated by the water in the swimming pool and the surrounding environment. The resonant frequency of the swimming pool can be determined by analyzing signals generated by strain gauge 332 being driven as a sound generation device and subsequently detected using strain gauge 332 driven as a seismic or sound detection device, where any changes in the resonant frequency of the pool are used to detect a change in swimming pool contents so as to generate an alarm or other suitable indication.

In operation, system 300 utilizes multiple inputs from sound or pressure sensors, strain gauges, and other suitable sensors to determine whether an immersion event has occurred in a swimming pool. System 300 thus provides improved immersion detection capability and reduces the risk of a false indication.

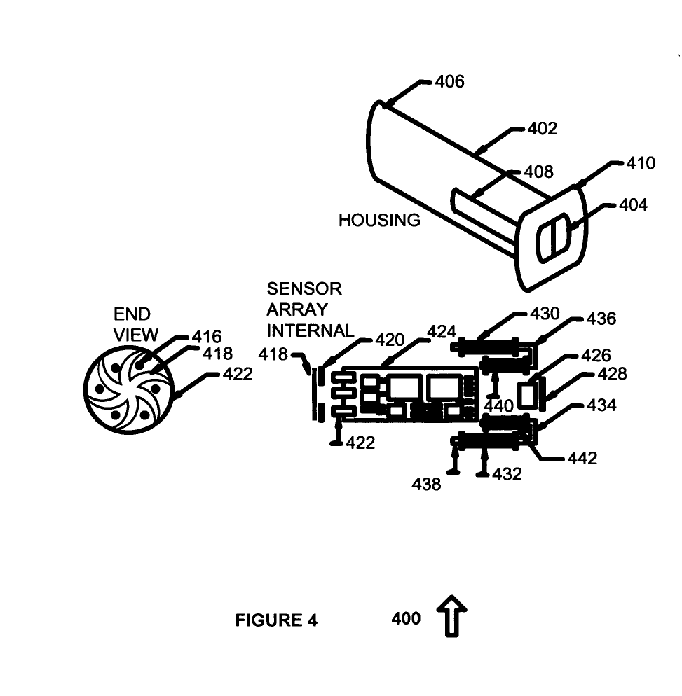

FIG. 4 is a diagram of a system 400 for providing a removable sensor array in accordance with an exemplary embodiment of the present invention. Optical and infrared detector 426 and lens 428 are contained within sensor array housing 402. The infrared detection capability of optical and infrared detector 426 can be used to detect objects in the water that have a temperature that is different from the surrounding water temperature, whether the detected object is in motion, the relative size of the object is, including measuring particulate size, and other suitable data. In another exemplary embodiment of the present invention, other frequencies of the light spectrum, both visible and invisible, from the far infrared to extreme ultraviolet, can be monitored and interferometers, refractometers, laser emitter and detectors, optical particulate detectors and comparators, turbidimeters, digital or analog video cameras and camera chips and devices, and other suitable systems can be used to detect temperature, motion, particle presence and size, optical recognition, optical refraction, optical measurement, optical clarity and other suitable variables.

In one exemplary embodiment of the present invention, sensor array 422 monitors pH, temperature, clarity, solids, and sanitizer action and can communicate either wirelessly, via wires or a fiber optic connection with a remote control panel, so as to provide a user with information regarding the overall pool water quality and condition. Sensor array 422 is housed in removable cartridge 402, which can be easily removed for cleaning.

System 400 utilizes inductively coupled power and communications that eliminates the need for electrical connections in the water. Two metallic armatures 434 and 436 transmit electric power and data via two coils 440 and 442 that are contained within housing 402, and are encased in plastic rods 408 that protrude from either side of the front 420 of sensor array housing 402. As such, sensor array housing 402 seals metallic armatures 434 and 436 and other electronic components from exposure to water.

Water is driven across sensor array 422 by a seal-less magnetically coupled pump 418 that provides cleaning action and greatly reduces maintenance, or convection circulation or other mechanisms can be used to circulate water for analysis by sensor array 422. Changes in impedance between the sensors of sensor array 422 or other suitable data can be used to generate an indication that sensor array 422 requires cleaning. In one exemplary embodiment of the present invention, water is drawn into a rear cavity 406 of sensor array housing 402 by a magnetically driven pump impeller 418. Pump impeller 418 is driven by a magnetically coupled coil such as coil 310 that is mounted on tube 308 and that extends rearward from controller 320, so as to induce the rotation of the pump impeller 418 in either direction and impart axial thrust to the impeller as well. Pump impeller 418 is equipped with brushing surface 420 on the side of pump impeller 418 that faces the sensors 422 that are mounted flush in the wall of sensor array pump housing 412. Cleaning surface 420 combined with the axial thrust and rotation of impeller 418 imparts a cleaning action to the sensors that are mounted flush in the wall of sensor array pump housing 412, as well as providing protection against the pump being stalled by algae, organic material, or other debris. Feedback from sensors 422 is compared to signals fed to the pump drive coil arrangement 310 to determine the condition of the pump and the cleanliness of sensors 422 and signal the user if maintenance is required. The water driven through rear cavity 406 of sensor array housing 402 is sampled by sensors 422, and the pH, resistivity, temperature, density, particulate content, clarity, Oxidizer activity, and then combined with intelligence from the optical infrared detector 426 the overall quality of the water and swimming condition is calculated and communicated to the remote control panel.

In another exemplary embodiment of the present invention, sensors are used to communicate levels of chlorine, oxygen, bromine, ozone, nitrous oxide, sulfur dioxide, iron, copper, other metals and rare earths, phosphates, iodines, salts, total alkalinity, organics, specific molecular membrane detectors, and chemical receptor detectors, electrical activity and properties, and other specific sensors that would be defined by user requirements.

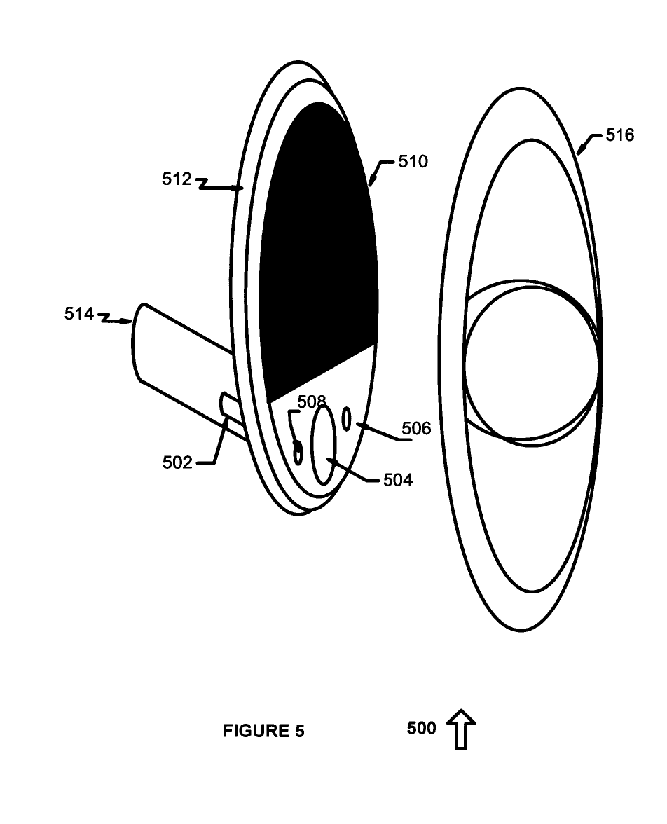

FIG. 5 is a diagram of a sensor housing assembly 500 in accordance with an exemplary embodiment of the present invention. Housing ports 504, 506 and 508 in the front of lens 510 are used to receive a removable sensor such as sensor 400. Potting compounds can also be used to seal housings and protect electronic components from moisture migration.

LED display 326 is mounted in an array on LED printed circuit board 328 and shines through lens 510, so as to illuminate the pool water with sufficient light to assist with water quality analysis, motion detection and other functions. In one exemplary embodiment, LED display 326 provides the equivalent light of a 300 watt incandescent pool light with programmable colors and can be the same size as a standard pool light assembly and can mount in a standard size pool light mounting niche. The lighting system is powered by a safe low voltage 24 volt DC power source instead of the conventional light that requires 120 VAC source that is equipped with a Class “A” ground fault circuit interrupter (GFCI) device.

In another embodiment of the present invention, LED printed circuit board 328 is connected to controller 320 via connector 318 to communicate commands to LED printed circuit board 328, such as those received from the remote control panel. Random light shows, pre-programmed light shows, fixed color and brightness levels sequenced by timer, as well as light and color displays that respond to music and swimmer initiated by intelligence communicated by the acoustic, seismic, optical and pressure sensors to provide an interactive light display are available to the user.

The light is controlled remotely by any one of the controller panel 218 that are mounted within the influence of a radio communications system, or connected via a wired or fiber optic network, The light can be dimmed from completely dark to full brightness and adjusted across a full range of colors. Favorite brightness levels and color schemes can be saved and recalled from a control panel. There is a random color light show mode available, and an activity responsive mode that responds to activity in and around the water as well as swimmer action.

The combination of alarm conditions can be readily programmed via a keypad 218 or other suitable controllers that are mounted within the influence of a radio communications system, or connected via a wired or fiber optic network, and the alarm condition can be communicated to a local or remote security system, auto-dialer, security service, an alarm service, fire department, police department, medical service, or any other monitored service. Any activity detected by the sensors is logged and date stamped, whether it is authorized by a password entered in one of the control panels, or an actual alarm event.

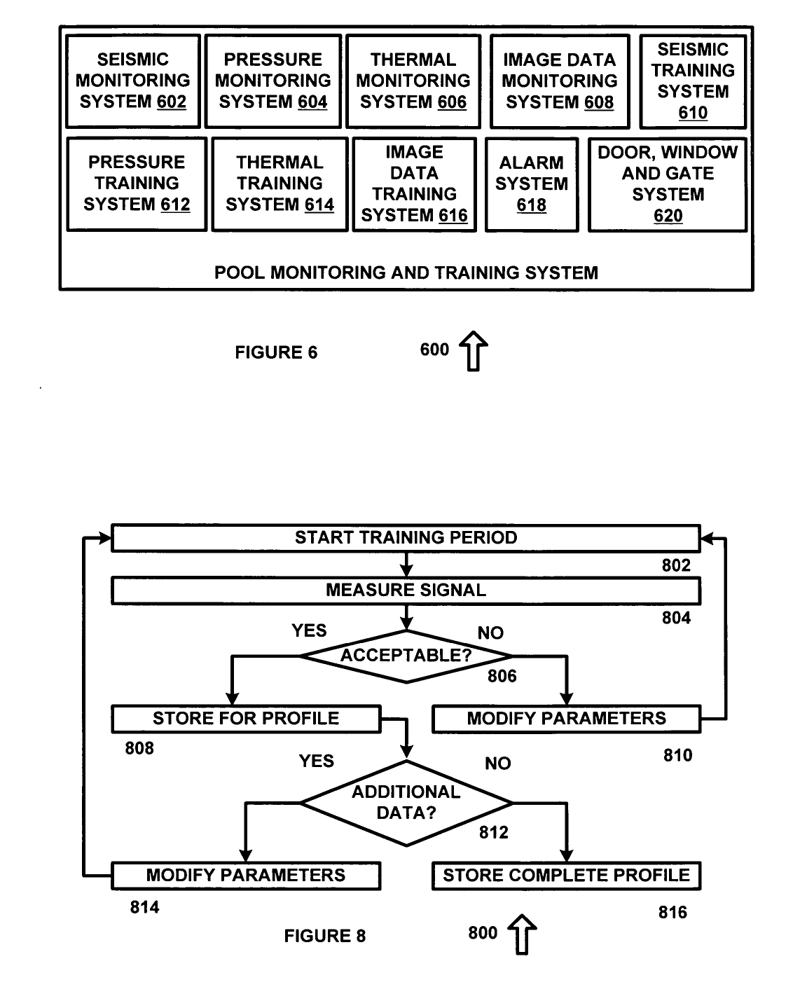

FIG. 6 is a diagram of a system 600 for monitoring swimming pool conditions in accordance with an exemplary embodiment of the present invention. System 600 includes seismic monitoring system 602, pressure monitoring system 604, thermal monitoring system 606, image data monitoring system 608, seismic training system 610, pressure training system 612, thermal training system 614 image data training system 616, alarm system 618 and door, window and gate system 620, each of which can be implemented in hardware, software, or a suitable combination of hardware and software, and which can be one or more software systems operating on a processing platform. As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications or on two or more processors, or other suitable software structures. In one exemplary embodiment, software can include one or more lines of code or other suitable software structures operating in a general purpose software application, such as an operating system, and one or more lines of code or other suitable software structures operating in a specific purpose software application.

Seismic monitoring system 602 receives data from an accelerometer, strain gauge or other sensors and determines whether changes in sensor data indicate that an immersion event has occurred. In one exemplary embodiment, the resonant frequency of a swimming pool can be determined from analysis of the sensor data, and changes in the resonant frequency that indicate an immersion event can be used to generate an indication, such as one of two or more indications that are used to generate an immersion alarm, where the two or more indications are used to avoid false alarms. In another exemplary embodiment, the seismic sensor can be placed at a focal point of a cavity that is in contact with the swimming pool water, such as a hyperbolic pool light cavity that provides amplification of seismic data. Likewise, changes in seismic indications over time, successive seismic indications, or other suitable data can be used to generate an immersion alarm.

Pressure monitoring system 604 receives data from a pressure sensor and determines whether changes in sensor data indicate that an immersion event has occurred. In one exemplary embodiment, the pressure data can be compared to set points, historical data, or other suitable data and can be used to generate an indication, such as one of two or more indications that are used to generate an immersion alarm, where the two or more indications are used to avoid false alarms. Likewise, changes in pressure indications over time, successive pressure indications, or other suitable data can be used to generate an immersion alarm.

Thermal monitoring system 606 receives data from a thermal sensor, such as an infrared detector, and determines whether changes in sensor data indicate that an immersion event has occurred. In one exemplary embodiment, the thermal data can be used to detect the presence of an object in a swimming pool that has a temperature that is different from the temperature of the pool water, and upon detection of such an object an indication can be generated, such as one of two or more indications that are used to generate an immersion alarm, where the two or more indications are used to avoid false alarms. Likewise, the relative size of the detected object can be determined, such as from a number of pixels, changes in thermal indications over time, successive thermal indications, or other suitable data can be used to generate an immersion alarm.

Image data monitoring system 608 receives image data from a camera or other sensors and determines whether changes in image data indicate that an immersion event has occurred. In one exemplary embodiment, the image data can be analyzed to determine whether a change in image data between two frames indicates that an object exceeding a predetermined size threshold has entered a swimming pool, or other suitable processes can be used. Upon detection of such an object an indication can be generated, such as one of two or more indications that are used to generate an immersion alarm, where the two or more indications are used to avoid false alarms. Likewise, the relative size of the detected object can be determined, such as from a number of pixels, changes in image data over time, successive image data sets, or other suitable data can be used to generate an immersion alarm. Likewise, image data can be analyzed using a turbidimeter, reflectivity can be determined based upon known illumination intensity or other suitable data can be analyzed to provide water quality indications. In this exemplary embodiment, the frequency and intensity of a light source can be varied to as to generate turbidity, reflectivity, or other suitable data so as to determine the concentration of suspended organic or inorganic solids or other suitable data.

Seismic training system 610 receives data from an accelerometer, strain gauge or other sensors and develops histogram or other suitable data that is used to determine whether an immersion event has occurred. In one exemplary embodiment, seismic training system 610 can receive a training start signal, after which seismic data is monitored and stored for use in detecting immersion events, footsteps on a pool deck, or other suitable data. As previously described, training can be performed for one or more standard swimming pool shapes and sizes, using a life-size test manikin and a plurality of different entry points and processes. Likewise, customized training can be performed for a specific swimming pool. Seismic training system 610 allows a user to store the standard or customized profile data for later retrieval or selection by a user.

Pressure training system 612 receives data from a pressure sensor other suitable sensors and develops histogram or other suitable data that is used to determine whether an immersion event has occurred. In one exemplary embodiment, pressure training system 612 can receive a training start signal, after which pressure data is monitored and stored for use in detecting immersion events or other suitable data. As previously described, training can be performed for one or more standard swimming pool shapes and sizes, using a life-size test manikin and a plurality of different entry points and processes. Likewise, customized training can be performed for a specific swimming pool. Pressure training system 612 allows a user to store the standard or customized profile data for later retrieval or selection by a user.

Thermal training system 614 receives data from a thermal sensor, such as an infrared detector, and develops histogram or other suitable data that is used to determine whether an immersion event has occurred. In one exemplary embodiment, thermal training system 614 can receive a training start signal, after which thermal data is monitored and stored for use in detecting immersion events or other suitable data. As previously described, training can be performed for one or more standard swimming pool shapes and sizes, using a life-size test manikin that has been heated to body temperature, and a plurality of different entry points and processes. Likewise, customized training can be performed for a specific swimming pool. Thermal training system 614 allows a user to store the standard or customized profile data for later retrieval or selection by a user.

Image data training system 616 receives image data from a camera or other sensors and develops histogram or other suitable data that is used to determine whether an immersion event has occurred. In one exemplary embodiment, image data training system 616 can receive a training start signal, after which image data is monitored and stored for use in detecting immersion events or other suitable data. As previously described, training can be performed for one or more standard swimming pool shapes and sizes, using a life-size test manikin and a plurality of different entry points and processes. Likewise, customized training can be performed for a specific swimming pool. Training can also be performed utilizing an illumination source, such as for nighttime operation. Image data training system 616 allows a user to store the standard or customized profile data for later retrieval or selection by a user.

Alarm system 618 receives indications from one or more of a gate sensor, a door sensor, a window sensor, seismic monitoring system 602, pressure monitoring system 604, thermal monitoring system 606 and image data monitoring system 608, and generates an alarm signal based on the indications. In one exemplary embodiment, alarm system 618 can include a plurality of settings, such as where a first setting is used when the indications from the gate sensor, door sensor and window sensor indicate that the associated gate, door and window are closed, and progressively different settings if the indications from the gate sensor, door sensor and window sensor indicate that one or more of the associated gate, door and window are opened. In this exemplary embodiment, an alarm for an immersion event can be generated if two or more indications from seismic monitoring system 602, pressure monitoring system 604, thermal monitoring system 606 and image data monitoring system 608 are received at the first setting, but the alarm may be generated if only one of the indications is received from seismic monitoring system 602, pressure monitoring system 604, thermal monitoring system 606 and image data monitoring system 608 at the progressively different settings. For example, the alarm may be generated only if indications are received from each of seismic monitoring system 602, pressure monitoring system 604, thermal monitoring system 606 and image data monitoring system 608 if there is no indication of an open door, window or gate, and the number of indications can be reduced with each additional indication of an open door, window or gate. Other suitable combinations of alarms and indications can be used.

Door, window and gate system 620 receives sensor data from one or more of a door sensor, a window sensor, a gate sensor, or a plurality of such sensors, and generates an indication based on the state of the door, window and gate based on the sensor data. In one exemplary embodiment, door, window and gate system 620 can generate indications that allow alarm system 618 to change settings, such as based on a door, window or gate being open or having been opened within a predetermined time. In this exemplary embodiment, the state of a door, window, gate, or combination of doors, windows and gates can be used to increase or decrease the sensitivity to an immersion alarm. Likewise, different alarms can be generated based on the state of a door, window, gate, or combination of doors, windows and gates, such as a chime when a single door, window or gate is opened, or an audible siren when two or more of a door, window or gate is opened. Likewise, other suitable settings and combinations can be used to indicate the status of doors, windows or gates or to change immersion detection sensitivity settings.

In operation, system 600 allows data from multiple sensors to be used to detect immersion events, monitor water quality, and to provide other suitable functions. System 600 can utilize multiple indications from different sensors so as to reduce false immersion event indications, and allows sensors to be trained to detect events for a standard swimming pool, different common swimming pool shapes, a customized application, or in other suitable manners.

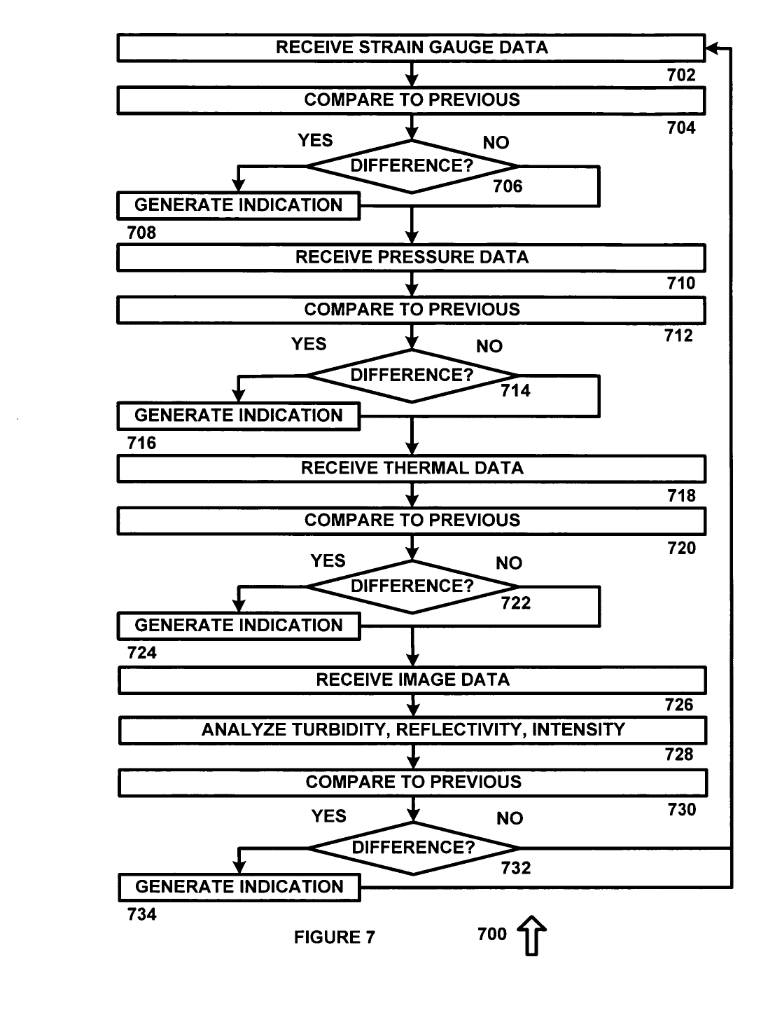

FIG. 7 is a flow chart of a method 700 for monitoring swimming pools in accordance with an exemplary embodiment of the present invention. Method 700 begins at 702 where strain gauge data is received. In one exemplary embodiment, the strain gauge data can be received from a strain gauge mounted on a corrugated support that is used to place the strain gauge at the focal point of a hyperbolic cavity on the side of a swimming pool, so as to focus seismic vibrations and other signals on the strain gauge. The strain gauge data can also be analyzed, such as to determine the resonant frequency of the swimming pool or other suitable data. The method then proceeds to 704.

At 704, the strain gauge data is compared to previous strain gauge data, such as to determine whether a difference exceeds a predetermined allowable difference, to determine whether the resonant frequency of the swimming pool has changed beyond a predetermined allowable range, or other suitable data. The method then proceeds to 706, where it is determined whether a difference that is greater than allowed has been measured. If no significant difference has been measured, the method proceeds to 710, otherwise, the method proceeds to 708 where an indication is generated. In one exemplary embodiment, the indication can be used with one or more other indications to generate an alarm representing an immersion event, such as if a person falls into a swimming pool after a detection system has been armed to detect any such immersion. Likewise, the indication can be used with previous indications, such as by comparing the indications, by counting a number of prior indications, or in other suitable manners. The method then proceeds to 710.

At 710, pressure data is received. In one exemplary embodiment, the pressure data can be received from a pressure sensor mounted in a hyperbolic cavity on the side of a swimming pool, such as at a focal point to focus pressure variations and other signals on the pressure sensor. The pressure sensor data can be generated in response to an impulse test signal at a predetermined frequency that is used to measure a resonant frequency of a swimming pool. The pressure sensor data can also be analyzed, such as to determine whether pressure variations exceed predetermined allowable limits or other suitable data. The method then proceeds to 712.

At 712, the pressure data is compared to previous pressure data, such as to determine whether a difference exceeds a predetermined allowable difference or other suitable data. The method then proceeds to 714, where it is determined whether a difference that is greater than allowed has been measured. If no significant difference has been measured, the method proceeds to 718, otherwise, the method proceeds to 716 where an indication is generated. In one exemplary embodiment, the indication can be used with one or more other indications to generate an alarm representing an immersion event, such as if a person falls into a swimming pool after a detection system has been armed to detect any such immersion. Likewise, the indication can be used with previous indications, such as by comparing the indications, by counting a number of prior indications, or in other suitable manners. The method then proceeds to 718.

At 718, thermal data is received. In one exemplary embodiment, the thermal data can be received from a thermal imaging sensor mounted behind a lens in a hyperbolic cavity on the side of a swimming pool. The thermal data can also be analyzed, such as to determine whether thermal variations exceed predetermined allowable limits, whether the size of object exceeds a predetermined allowable size, or other suitable data. The method then proceeds to 720.

At 720, the thermal data is compared to previous thermal data, such as to determine whether a difference exceeds a predetermined allowable difference or other suitable data. The method then proceeds to 722, where it is determined whether a difference that is greater than allowed has been measured. If no significant difference has been measured, the method proceeds to 726, otherwise, the method proceeds to 724 where an indication is generated. In one exemplary embodiment, the indication can be used with one or more other indications to generate an alarm representing an immersion event, such as if a person falls into a swimming pool after a detection system has been armed to detect any such immersion. Likewise, the indication can be used with previous indications, such as by comparing the indications, by counting a number of prior indications, or in other suitable manners. The method then proceeds to 726.

At 726, image data is received. In one exemplary embodiment, the image data can be received from a camera or other suitable image data sensor mounted behind a lens in a hyperbolic cavity on the side of a swimming pool. The image data can also be analyzed, such as to determine whether the primitive that represent objects or other suitable data has been detected. The method then proceeds to 728.

At 728, turbidity, reflectivity, intensity and other suitable data is analyzed. In one exemplary embodiment, a turbidimeter or other suitable devices can be used to analyze the optical data to generate data representing the amount of suspended solids. Likewise, image data can be generated using difference frequencies of light so as to detect different suspended solids, such as organic, inorganic, or other suitable solids. The data can be transmitted to a system for analyzing water quality, a display, or other suitable systems. The method then proceeds to 730.

At 730, the image data is compared to previous image data, such as to determine whether a difference exceeds a predetermined allowable difference or other suitable data. In one exemplary embodiment, a pixel histogram can be used to compare two previous frames of image data, such that a parameter or parameters of the histogram are compared with predetermined allowable values for such parameters. The method then proceeds to 732, where it is determined whether a difference that is greater than allowed has been measured. If no significant difference has been measured, the method returns to 702, otherwise, the method proceeds to 734 where an indication is generated. In one exemplary embodiment, the indication can be used with one or more other indications to generate an alarm representing an immersion event, such as if a person falls into a swimming pool after a detection system has been armed to detect any such immersion. Likewise, the indication can be used with previous indications, such as by comparing the indications, by counting a number of prior indications, or in other suitable manners. The method then returns to 702.

In operation, method 700 allows continuous monitoring of different types of data in order to detect immersion events with little or no false positive indications, and also allows water quality to be monitored. The order of steps shown in method 700 is exemplary, and the steps shown can be arranged in other suitable orders, can be performed in parallel, or other suitable processes can be used.

FIG. 8 is a flow chart of a method 800 for training a sensor to detect an immersion event in accordance with an exemplary embodiment of the present invention. Method 800 begins at 802, where a training period is initiated. In one exemplary embodiment, a training period can be a predetermined period of time over which measurements are taken, such as two seconds. In another exemplary embodiment, the training event can include the generation of a sound or pressure impulse, illumination of a lighting device, or other suitable active sensing events. The method then proceeds to 804.

At 804, a signal is measured from a sensor while a training event is performed. In one exemplary embodiment, a seismic sensor output can be measured while a user walks on a pool deck, while a manikin is placed, thrown, rolled or dropped into a pool, or other suitable events can be simulated. In another exemplary embodiment, a pressure sensor output, infrared sensor output, optical sensor output or other suitable sensors can also or alternatively be used for training. The method then proceeds to 806.

At 806, it is determined whether an acceptable signal has been measured, such as a signal that includes event data that can be distinguished from background data. If it is determined that an acceptable signal has been measured, the method proceeds to 808 where the signal is stored to a profile for comparison under operating conditions. If it is determined that an unacceptable signal has been received, the method proceeds to 810, where one or more parameters are modified. For example, where the signal is measurement of a seismic or pressure sensor over a predetermined frequency range in response to an impulse driver event, a user might select a different frequency range in response to an unacceptable signal. Likewise, where the signal is optical image sensor data under predetermined lighting conditions, the user may select different lighting conditions. The method then returns to 802.

After a signal is stored to a profile at 808, the method proceeds to 812 where it is determined whether additional data is required. In one exemplary embodiment, at least two different acceptable sensor inputs can be obtained so as to provide redundant detection of an immersion event, and if less than two different acceptable sensor inputs have been received, the method can proceed to 814, where additional parameters can be provided. In one exemplary embodiment, where an acceptable seismic sensor input has been received, a user can be prompted to select from one or more of an infrared sensor input, a pressure sensor input, and an optical sensor input, as well as one or more different active sensor parameters such as a frequency range for monitoring in response to an impulse, a frequency range for optical illumination, or other suitable data. The method then returns to 802.

If it is determined at 812 that additional data is not required, the method proceeds to 816 where a complete profile is stored. In one exemplary embodiment, the profile can include the type of profile (e.g., standard, pool shape and size parameters, or custom), the types of sensors that should be monitored (e.g. door, window, gate, seismic, pressure, infrared, or optical), active sensor inputs (e.g. frequency ranges to be monitored, light frequency or intensity settings), or other suitable data so as to allow configurable sensor settings to be stored to improve monitoring and detection efficiency.

In view of the above detailed description of the present invention and associated drawings, other modifications and variations are apparent to those skilled in the art. It is also apparent that such other modifications and variations may be effected without departing from the spirit and scope of the present invention.

What is claimed is:

1. A system for monitoring a swimming pool comprising:
a parabolic housing;
a seismic sensor at or near a focal point of the parabolic housing generating a seismic signal;
a seismic monitoring system receiving the signal and analyzing the signal to determine whether an immersion event has occurred;
a pressure sensor internal to the parabolic housing mounted at or near a focal point of the parabolic housing generating, the pressure sensor generating a pressure signal;
a pressure monitoring system receiving the pressure signal and analyzing the pressure signal to determine whether an immersion event has occurred; and
an optical sensor internal to the parabolic generating an optical signal; and
an optical monitoring system receiving the optical signal and analyzing the optical signal to determine whether an immersion event has occurred.

2. The system of claim 1 further comprising a removable sensor array.

3. The system of claim 1 further comprising a water quality metering system.

4. The system of claim 1 further comprising:
a controllable light source; and
a water quality metering system, wherein the light source is controlled to facilitate the operation of the water quality metering system.

5. The system of claim 1 further comprising a thermal imaging system.

6. A removable sensor array comprising:
a waterproof housing;
an energy coupling receiving power from an external power source; and
one or more sensors.

7. The removable sensor array of claim 6 wherein the one or more sensors comprise one or more of an infra-red sensor, a pressure sensor, and an image data sensor.

8. The removable sensor array of claim 6 wherein the waterproof housing is configured to mate with a receptacle in a swimming pool light.

9. The removable sensor array of claim 6 wherein the energy coupling comprises an inductive coupling.

10. The removable sensor array of claim 6 further comprising a data coupling for receiving data from and transmitting data to the removable sensor array.

11. A system for detecting motion comprising:
means for generating a first signal representing seismic data;
means for generating a second signal; and
wherein a motion detection signal is generated based on the first signal and the second signal.

12. The system of claim 11 wherein the means for generating a second signal comprises means for generating the second signal representing thermal data.

13. The system of claim 11 wherein the means for generating a second signal comprises means for generating the second signal representing pressure data.

14. The system of claim 11 wherein the means for generating a second signal comprises means for generating the second signal representing image data.

15. The system of claim 11 further comprising means for analyzing the first signal and the second signal.

16. A method for monitoring a swimming pool comprising:
receiving a seismic data signal;
determining a resonant frequency of the swimming pool;
determining whether a change in the resonant frequency of the swimming pool has occurred; and
generating an indication if the change in the resonant frequency of the swimming pool has occurred.

17. The method of claim 16 further comprising:
receiving a thermal data signal;
determining whether a change in a thermal profile of the swimming pool has occurred; and
generating an indication if the change in the thermal profile of the swimming pool has occurred.

18. The method of claim 16 further comprising:
receiving a pressure data signal;
determining whether a change in pressure data has occurred; and
generating an indication if the change in the pressure data has occurred.

19. The method of claim 16 further comprising:
receiving an optical data signal;
determining whether a change in optical data has occurred; and
generating an indication if the change in the optical data has occurred.

20. The method of claim 16 wherein receiving a seismic data signal comprises:
generating an impulse signal; and
receiving the seismic data signal over a predetermined frequency range.

21. A system for detecting an immersion event comprising:
a training system receiving training data and storing the training data;
a sensor generating a data signal; and
a monitor system receiving the training data and the data signal and generating an indication if the data signal is within a predetermined range of the training data.

22. The system of claim 21 wherein the training system comprises a seismic training system storing seismic training data, the sensor comprises a seismic sensor generating a seismic data signal, and the monitor system comprises a seismic monitoring system receiving the seismic training data and the seismic data signal and generating an indication if the seismic data signal is within a predetermined range of the seismic training data.

23. The system of claim 21 wherein the training system comprises an infrared training system storing infrared training data, the sensor comprises an infrared sensor generating an infrared data signal, and the monitor system comprises an infrared monitoring system receiving the infrared training data and the infrared data signal and generating an indication if the infrared data signal is within a predetermined range of the infrared training data.

24. The system of claim 21 wherein the training system comprises a pressure training system storing pressure training data, the sensor comprises a pressure sensor generating a pressure data signal, and the monitor system comprises a pressure monitoring system receiving the pressure training data and the pressure data signal and generating an indication if the pressure data signal is within a predetermined range of the pressure training data.

25. The system of claim 21 further comprising:
a second training system receiving second training data and storing the second training data;
a second sensor generating a second data signal;
a second monitor system receiving the second training data and the second data signal and generating a second indication if the second data signal is within a predetermined range of the second training data; and
an alarm system receiving the first indication and the second indication and generating an alarm signal.
